(19) United States
(12) Patent Application Publication
(10) Pub. No.: US 2007/0077385 A1
(43) Pub. Date: Apr. 5, 2007

(54) Universal magnetic customizable promotional piece

(76) Inventor: Shawn W. Mallett, Vincent, OH (US)

Correspondence Address: GALLAGHER & DAWSEY CO., L.P.A., P.O. BOX 785, COLUMBUS, OH, 43216, US

(21) Appl. No.: 11/524,854

(22) Filed: Sep. 21, 2006

Related U.S. Application Data
(60) Provisional application No. 60/722,322, filed on Sep. 30, 2005.

(51) Int. Cl. B32B 33/00

(52) U.S. Cl. 428/40.1; 428/99

(57) ABSTRACT

A universal magnetic customizable promotional piece accepts permanent attachment of a customized attachment. The universal magnetic customizable promotional piece has a primary substrate with a display surface and a rear surface. The display surface may be divided into a universal promotion display portion and a customizable attachment display portion with a demarcation line separating the two portions. The customizable attachment display portion is covered in part by a permanent adhesive layer. The customized attachment is permanently attached to the primary substrate by the permanent adhesive layer. A release liner covers the permanent adhesive layer prior to attachment of the customized attachment. The customized attachment may be a standard size business card. A magnetic substrate is attached to the primary substrate rear surface. The magnetic substrate allows the universal magnetic customizable promotional piece to be releasably magnetically attached to a ferrous object.

### RELATED APPLICATIONS

This application claims the benefit of U.S. provisional patent application Ser. No. 60/722,322, filed Sep. 30, 2005, all of which is incorporated by reference as if completely written herein.

### STATEMENT REGARDING FEDERALLY SPONSORED RESEARCH OR DEVELOPMENT

This invention was not made as part of a federally sponsored research or development project.

### TECHNICAL FIELD

The present invention relates to the field of promotional display products with a magnetic surface for releasable magnetic attachment to a ferrous object; and more particularly, to promotional display products having a permanent adhesive for permanent attachment of a customized attachment to a preprinted advertisement that has a magnetic substrate.

### BACKGROUND OF THE INVENTION

The present invention relates to customized promotional products. The current practice in this industry is to personalize specific items, such as magnets, pens, and calendars, by adding unique promotional material to the items. Usually the unique promotional material is added by means of costly graphic design and small production runs for each individual purchaser. While the customized promotional products may have a professional appearance, the cost is high. The personalized promotional items are distributed to, for example, customers or potential customers. Since the item is personalized, the recipient has a regular reminder of the person who provided the item. Hopefully, as a consequence, the provider of the customized promotional item will keep or gain business by distribution of the customized promotional item. Unfortunately, the promotional items may be thrown away. Therefore, cost of the promotional items should be kept low, yet the promotional items must have a professional appearance.

The current customized products that are available on the market are expensive because they must be customized or personalized at the printing facility. That is, the printing facility must have all of the customized or personal information before the item can be finished and shipped. The customization of these products is expensive because it is done at the print shop where the personalization is printed directly on the product.

What has been missing in the art is a low cost alternative to expensive print-shop customized promotional products. In particular, the art has been missing a universal promotional piece capable of being customized, with the individualized contact and advertising information added by the customer, not by a print shop. Moreover, a promotional piece that may be manufactured in large volumes to provide a cost effective and aesthetically appealing promotional item that provides the look of a custom, professionally printed promotional piece.

### SUMMARY OF INVENTION

In its most general configuration, the present invention advances the state of the art with a variety of new capabilities and overcomes many of the shortcomings of prior methods in new and novel ways. In its most general sense, the present invention overcomes the shortcomings and limitations of the prior art in any of a number of generally effective configurations.

A universal magnetic customized promotional piece has a primary substrate. The primary substrate has a primary substrate display surface and a primary substrate rear surface. The primary substrate is composed of a universal promotion display portion and a customizable attachment display portion separated by a demarcation line.

The customizable attachment display portion has a customizable attachment display surface and a customizable attachment rear surface. The customizable attachment display surface may be covered in part by a permanent adhesive layer. In one embodiment, a customized attachment is permanently affixed to the primary substrate by the permanent adhesive layer. A release liner prevents other objects from inadvertently adhering to the permanent adhesive layer. The release liner has a release liner exterior surface and a release liner contact surface. The release liner is located with the release liner contact surface releasably covering the permanent adhesive layer, and may be easily removed from the permanent adhesive layer by hand. A magnetic substrate is attached to the rear surface of the primary substrate. A magnetic substrate exterior surface allows the universal magnetic customizable promotional piece to be magnetically, releasably attached to ferrous objects.

In one particular embodiment, the primary substrate has a primary substrate width that is substantially equal to a customized attachment width of the customized attachment and the customized attachment is a standard sized business card.

In another embodiment of the instant invention, the demarcation line may be a separation line allowing the universal promotion display portion to be torn from the customizable attachment display portion. Additionally, the universal promotion display surface may have universal indicia, such as calendars, sports schedules, emergency contacts, among others, printed thereon. Other indicia may include attachment indicia, such as, how to remove a release liner and attach the customized attachment.

In an alternative embodiment of the present invention, the release liner may be formed with a gripping tab. The gripping tab may extend past the edge of the permanent adhesive layer. In yet another embodiment, the permanent adhesive layer may be comprised of at least two noncontiguous permanent adhesive layers. In still another embodiment of the present invention, the universal magnetic customizable promotional piece is equipped with the release liner having a drawstring and a liner passage. The release liner may be easily removed from the adhesive layer by pulling the drawstring and the release liner through the liner passage.

In yet another embodiment, the primary substrate is formed with an attachment recess having a recess perimeter. The attachment recess is substantially the same shape and size of customized attachment. The permanent adhesive layer resides on the magnetic substrate contact surface. As with other embodiments, the release liner covers the permanent adhesive layer. Upon removal of the release liner, the customizable attachment is permanently adhered to the permanent adhesive layer within the attachment recess.

Numerous variations, modifications, alternatives, and alterations of the various preferred embodiments, processes, and methods may be used alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 is a perspective view of an embodiment of the universal magnetic promotional piece, not to scale;

FIG. 2 is the front elevation view of an embodiment of a universal magnetic promotional piece, not to scale;

FIG. 3 is the rear elevation view of an embodiment of the universal magnetic promotional piece, not to scale;

FIG. 4 is the side elevation view of an embodiment of the universal magnetic promotional piece, not to scale;

FIG. 5 is a perspective view of an embodiment of the universal magnetic promotional piece, showing removal of a release liner, not to scale;

FIG. 6 is a front elevation view of an embodiment of the present invention in which a business card is a customized attachment, not to scale;

FIG. 7 is a perspective view of an embodiment of the universal magnetic promotional piece, showing various indicia on a customizable attachment display portion and on a universal promotion display portion, not to scale;

FIG. 8 is a perspective view of an embodiment with a plurality of permanent adhesive layers, not to scale;

FIG. 9 is a perspective view of an alternative embodiment with a gripping tab, not to scale;

FIG. 10 is a front elevation view of an alternative embodiment of the invention having a liner passage and a drawstring, not to scale;

FIG. 11 is a front elevation view of the embodiment of the invention shown in FIG. 10 with the drawstring being drawn through the liner passage, not to scale;

FIG. 12 is a front elevation view of yet another alternative embodiment of the present invention, not to scale; and

FIG. 13 is a cross-sectional view of the alternative embodiment of the present invention taken along section line 13-13 shown in FIG. 12, not to scale.

### DESCRIPTION OF THE INVENTION

A universal magnetic customized promotional piece (10) enables a significant advance in the state of the art. The preferred embodiments of the apparatus accomplish this by new and novel arrangements of elements that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

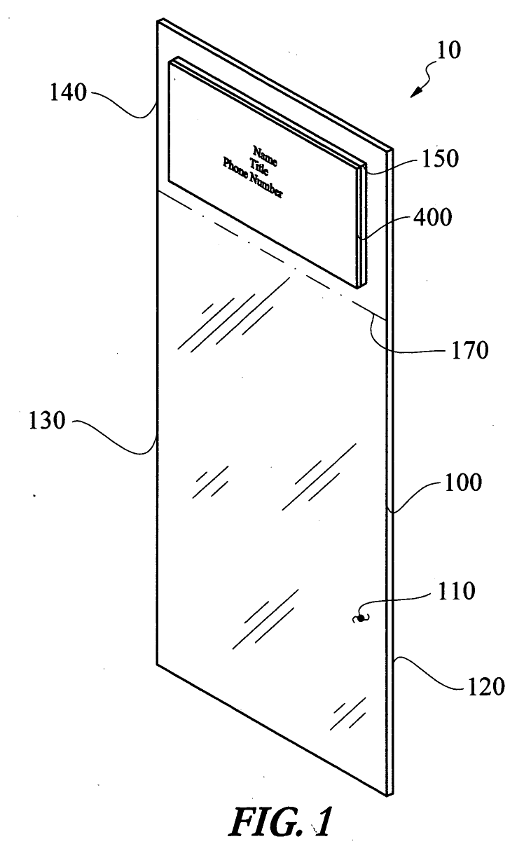

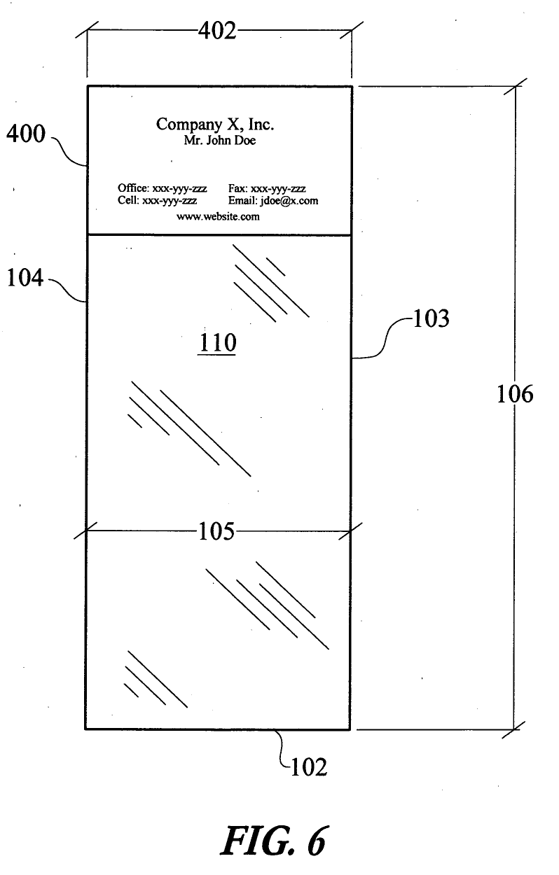

With reference to the FIG. 1, the universal magnetic customized promotional piece (10) is designed for the permanent attachment of a customized attachment (400) to a primary substrate (100) with a permanent adhesive layer (150). As seen in FIG. 1, in one embodiment of the instant invention, the primary substrate (100) may be paper, card stock, or plastic sheet of any one of a number of weights and colors, to name only a few. The primary substrate (100) has a primary substrate display surface (110) and a primary substrate rear surface (120), and has a primary substrate length (106), seen only in FIG. 6. Referring again to FIG. 1, the primary substrate (100) is composed of a universal promotion display portion (130) and a customizable attachment display portion (140) separated by a demarcation line (170). The demarcation line (170), by way of example and not limitation, may serve as a visual marker to which the customized attachment (400) is aligned, or it may be an imaginary line.

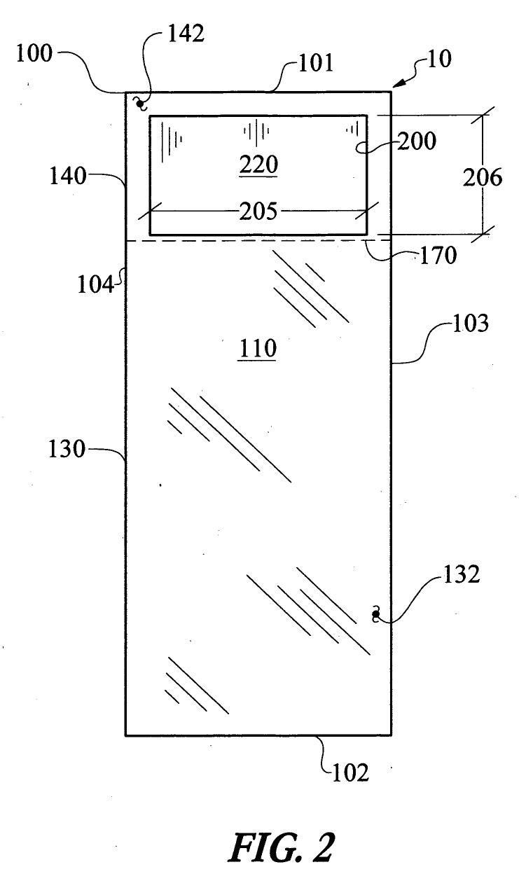

Referring now to FIG. 2, the universal promotion display portion (130) has a universal promotion display surface (132), and the customizable attachment display portion (140) has a customizable attachment display portion display surface (142). While FIG. 2 generally illustrates the customizable attachment display portion (140) located at one end of the primary substrate (100), the customizable attachment display portion (140) may be incorporated in other areas of the primary substrate (100). By way of example and not limitation, the customizable attachment display portion (140) may be located in the middle of the primary substrate (100). In this case, the universal promotion display portion (130) will surround the customizable attachment display portion (140) and the demarcation line (170) may outline the customizable attachment display portion (140). Consequently, there is nearly a limitless arrangement of the universal promotion display portion (130) together with the customizable attachment display portion (140).

With continued reference to the embodiment, as seen in FIG. 2, the universal promotion display portion (130) is substantially larger than the customizable attachment display portion (140). However, this is not necessarily always the situation. As one skilled in the art will observe, the relative sizes of the two portions (130, 140) depends upon the end use of the promotional piece (10). The end use may also determine the placement of the permanent adhesive layer (150). Also, in the embodiment of the promotional piece (10), as seen in FIG. 2, the primary substrate (100) is rectangular. One skilled in the art will recognize that the primary substrate (100) may have may shapes and sizes. However, when the primary substrate (100) is rectangular, it has a primary substrate proximal edge (101), a primary substrate distal edge (102), a primary substrate dextral edge (103), and a primary substrate sinistral edge (104).

A release liner (200), which will be described in more detail later, is seen in FIG. 2. The release liner (200) has a release liner exterior surface (220), a release liner width (205), and a release liner length (206).

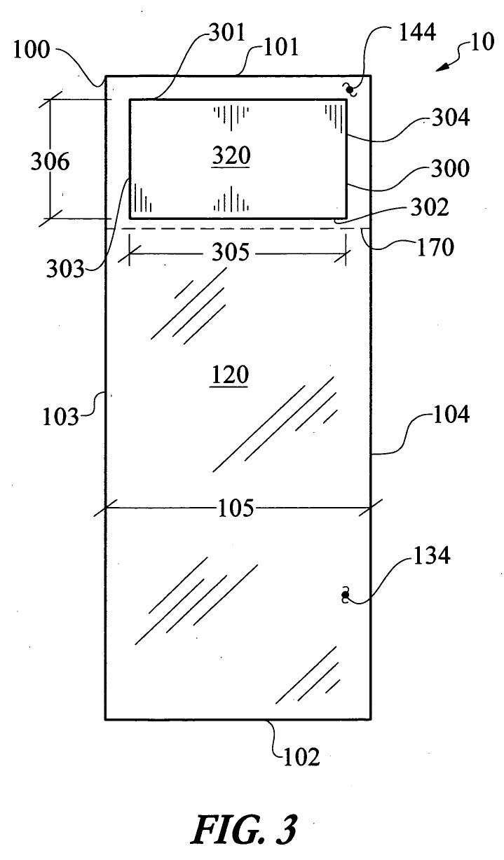

An embodiment of the primary substrate rear surface (120) is seen in FIG. 3. A magnetic substrate (300) is attached to the primary substrate rear surface (120). As seen in the embodiment of FIG. 3, the magnetic substrate (300) is attached to a customizable attachment rear surface (144). However, the magnetic substrate (300) may be attached to a universal promotion rear surface (134). In fact, multiple magnetic substrates (300) may be distributed between the universal promotion rear surface (134) and the customizable attachment rear surface (144).

The magnetic substrate (300) may have many shapes. However, in the case where the magnetic substrate (300) is rectangular in shape, as seen in FIG. 3, the magnetic substrate (300) has a magnetic substrate proximal edge (301), a magnetic substrate distal edge (302), a magnetic substrate dextral edge (303), a magnetic substrate sinistral edge (304), a magnetic substrate width (305), and a magnetic substrate length (306). The magnetic substrate proximal edge (301) may extend near, or be flush with, the primary substrate proximal edge (101). Likewise, the magnetic substrate distal edge (302) may extend near, or be flush with, the primary substrate distal edge (102). In the same fashion, the magnetic substrate dextral edge (303) and the magnetic substrate sinistral edge (304) may, individually and without dependence on the other, extend near, or be flush with, the primary substrate dextral edge (103) and primary substrate sinistral edge (104), respectively. In other words, in an embodiment of the instant invention, the magnetic substrate width (305) may be substantially equal to a primary substrate width (105). A magnetic substrate exterior surface (320) allows the universal magnetic customizable promotional piece (10) to be magnetically, releasably attached to ferrous objects.

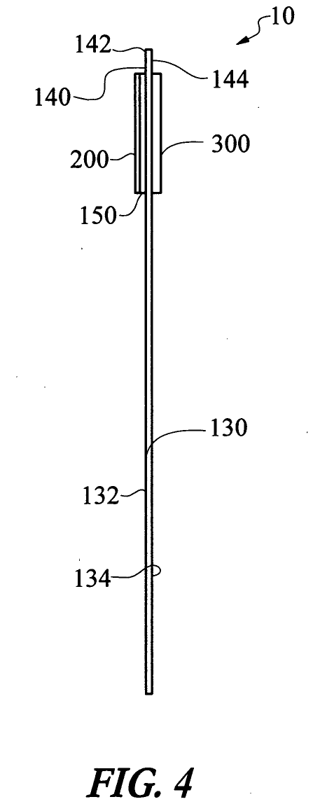

Referring now to FIG. 4, a customizable attachment display surface (142) may be covered in part by the permanent adhesive layer (150), as previously mentioned. To prevent other objects from inadvertently adhering to the permanent adhesive layer (150), it is covered with the release liner (200). In one embodiment of the instant invention, the magnetic substrate (300) is attached to the customizable attachment rear surface (144) and the permanent adhesive layer (150) is attached in a substantially opposing position on the customizable attachment display surface (142). The magnetic substrate (300) and the permanent adhesive layer (150) do not necessarily have to be attached to the primary substrate (100) on opposing sides of the primary substrate (100).

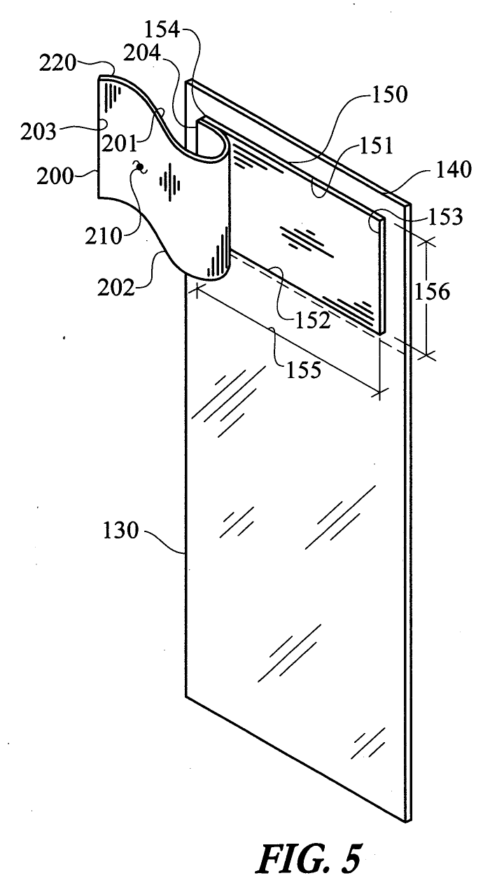

In one embodiment of the present invention, as seen in FIG. 5, the release liner (200) has a release liner contact surface (210) which releasably covers the permanent adhesive layer (150). The release liner (200) is designed so that it may be easily removed from the permanent adhesive layer (150) by hand thereby allowing the customized attachment (400), seen in FIGS. 1, 6, 11 and 13, to be brought in contact with the permanent adhesive layer (150) and permanently attached to the promotional piece (10). The release liner (200) may be a silicon coated material, or other non-stick material. The permanent attachment of the customized attachment (400) to the universal magnetic customizable promotion piece (10) contemplates the inability of removal of the customized attachment (400) without destroying or damaging the customized attachment (400), or the promotional piece (10), beyond repair.

With continued reference to FIG. 5, the release liner (200) and the permanent adhesive layer (150) are rectangular. However, neither the release liner (200) nor the permanent adhesive layer (150) need to be rectangular as other shapes will suffice to operate the present invention. In the embodiment of the invention where the release liner (200) is rectangular, the release liner may have a release liner proximal edge (201), a release liner distal edge (202), a release liner dextral edge (203), and a release liner sinistral edge (204), as seen in FIG. 5. Likewise, embodiments in which the release liner (200) covers the permanent adhesive layer (150) and has a substantially similar shape as the permanent adhesive layer (150), the permanent adhesive layer (150) will also have an adhesive layer proximal edge (151), an adhesive layer distal edge (152), an adhesive layer dextral edge (153), an adhesive layer sinistral edge (154), an adhesive layer width (155), and an adhesive layer length (156), as seen in FIG. 5.

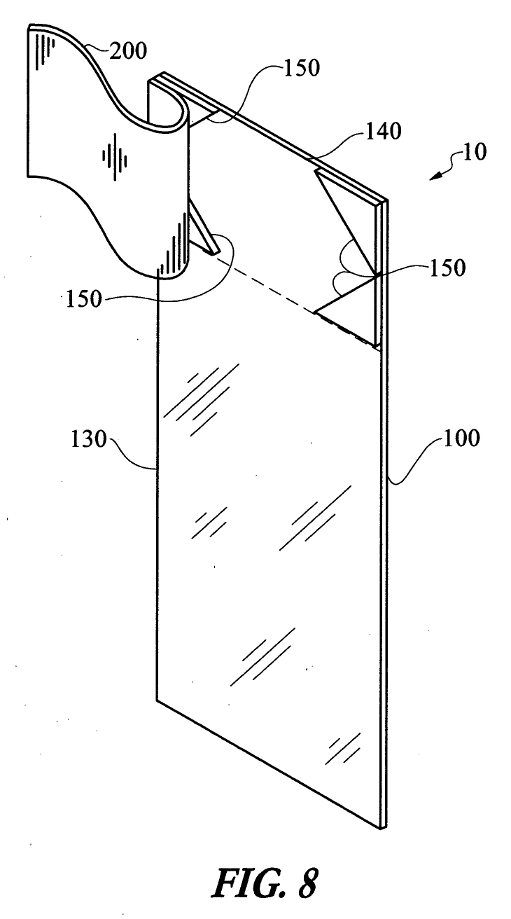

While, as seen in FIG. 5, the permanent adhesive layer (150) may cover most, or all, of the customizable attachment display portion (140), the permanent adhesive layer (150) may alternatively be multiple permanent adhesive layers (150) arranged as two or more rows or columns in the customizable attachment display portion (140). Or, by way of example and not limitation and as seen in FIG. 8, the permanent adhesive layer (150) may be comprised of at least two noncontiguous permanent adhesive layers (150) located in the customizable attachment display portion (140). The noncontiguous permanent adhesive layer (150) is arranged so that the permanent adhesive layers (150) are located at the corners of the customizable attachment display portion (140). By reducing the area of the permanent adhesive layer (150) further money savings are realized without reduction in the permanency of the attachment.

In one particular embodiment illustrated in FIG. 6, the primary substrate width (105) is substantially equal to a customized attachment width (402) and the customized attachment (400) is a standard sized business card. A standard sized business card is one generally available from print shops and from many office supply stores. The standard sized business card in the United States is commonly approximately 3.5 inches by approximately 2 inches. European standard business cards may be from approximately 85.6 millimeters by approximately 54 millimeters to approximately 125 millimeters by approximately 88 millimeters. When the primary substrate width (105) is substantially equivalent to the standard business card width, the uniformity creates a more convincing illusion that the universal magnetic customizable promotional piece (10) with the customizable attachment (400) is a single, uniform custom promotional piece.

As previously mentioned, in one particular embodiment, the customized attachment (400) is a business card that it commonly purchased in bulk. Therefore, substantial money is saved by purchasing the universal magnetic customizable promotional piece (10) in bulk for use by many different people, and then customizing the universal magnetic customizable promotional piece (10) by permanently adhering each individual's business card to the universal magnetic customizable promotional piece (10). By way of example and not limitation, the universal magnetic customizable promotion piece is an ideal product for franchises such as realty professionals, insurance agents, financial planners, and many other service and sales professionals.

Alternatively, in other situations where the customized attachment (400) is not rectangular, the surface area of the customizable attachment display surface (142) is substantially equal to the surface area of one side of the customized attachment (400). Again, this furthers the illusion of a single piece customized promotion.

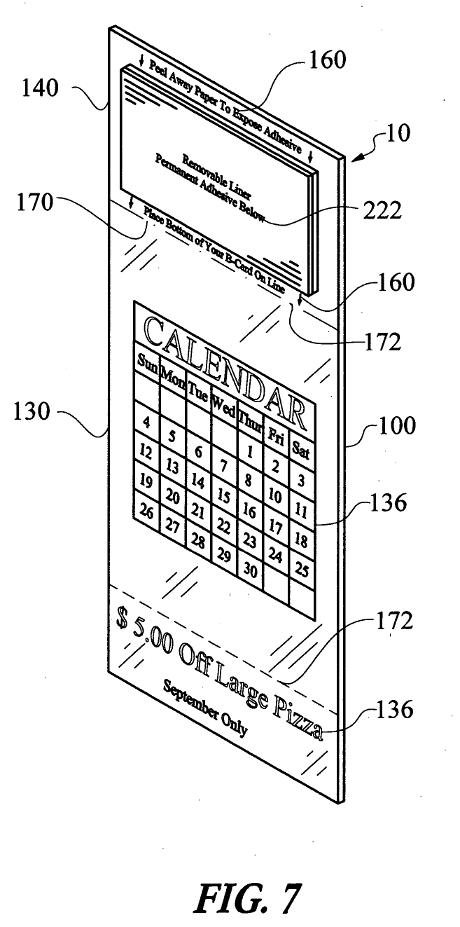

In another embodiment of the instant invention, as seen in FIG. 7, the demarcation line (170) may be a separation line (172). The separation line (172) is created by imparting a line of reduced strength in the primary substrate (100) thereby allowing the universal promotion display portion (130) to be torn from the customizable attachment display portion (140). In other embodiments, numerous separation lines (172) may be incorporated into the universal promotion display portion (130) to facilitate the incorporation of tear-away promotional items, such as a “$5.00 Off Large Pizza” coupon seen in FIG. 7. The separation line (172) need not be one continuous separation line (172) and, as one skilled in the art will observe and appreciate, may include one or more die cuts, perforations, indentations, score lines, and weakened fracture lines. Additionally, as seen in FIG. 7, the universal promotion display portion display surface (132) may include universal indicia (136). Such universal indicia (136) may include calendars, sports schedules, emergency contacts, among others. For example, other indicia may include attachment indicia (160), which can also be placed in the customizable promotion display portion (140), and a plurality of liner indicia (222) that provide instructions for removing the release liner (200).

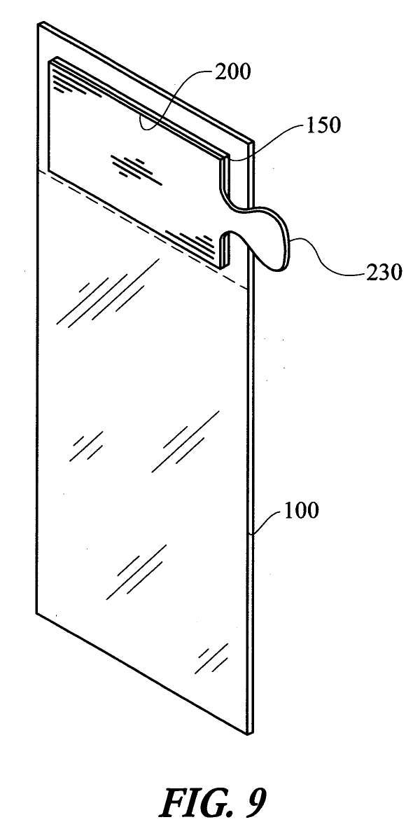

In another embodiment of the present invention, as seen in FIG. 9, the release liner (200) may be formed with a gripping tab (230) designed to provide the user with quick and easy removal of the release liner (200). In this embodiment the gripping tab (230) extends past the edge of the permanent adhesive layer (150). The gripping tab (230) allows for easy gripping and eliminates the difficulty of picking at an adhered edge. In a further embodiment, the gripping tab (230) extends past the edge of the primary substrate (100).

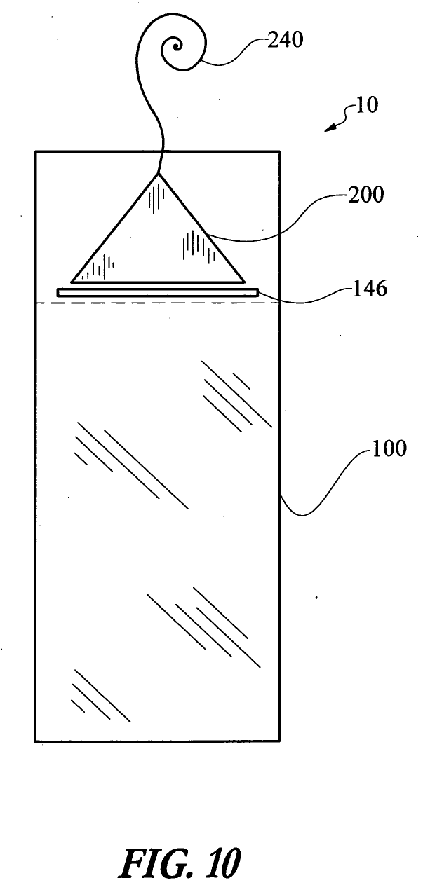

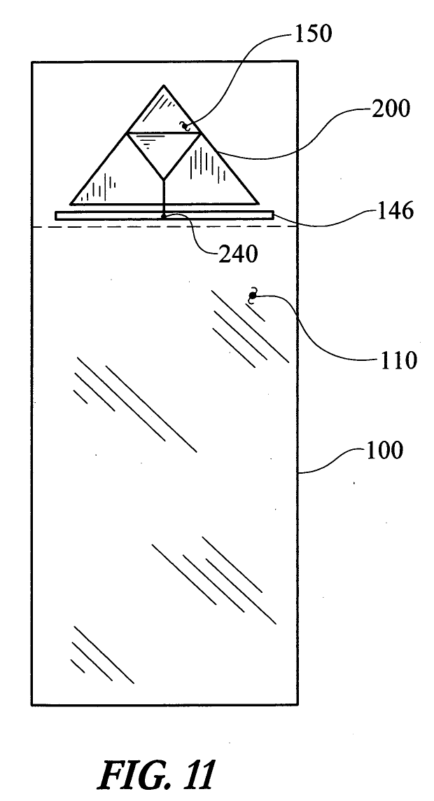

In still another embodiment of the present invention, seen in FIGS. 10 and 11, the universal magnetic customizable promotional piece (10) is equipped with the release liner (200) having a drawstring (240) and a liner passage (146). As seen in FIG. 11, the liner passage (146) is a channel through the primary substrate (100) that extends from the primary substrate display surface (110) to the primary substrate rear surface (120). The release liner (200) may be easily removed from the adhesive layer (150) by pulling the drawstring (240) and the release liner (200) through the liner passage (146), as shown in FIG. 11. This embodiment allows the user to preposition the customized attachment (400) (not shown) prior to exposing the permanent adhesive layer (150). Since the permanent adhesive layer (150) by its nature prevents the removal of the customized attachment (400), initial placement of the customized attachment (400) is crucial to the aesthetic, professional appearance of the universal magnetic customizable promotional piece (10) after customization. By first holding the customized attachment (400) in a desired position over the release liner exterior surface (220), prior to exposing the permanent adhesive (150), and then pulling the drawstring (240) and the release liner (200) through the liner passage (146), the customized attachment (400) will be permanently attached in the customizable attachment display portion (140) in the desired location.

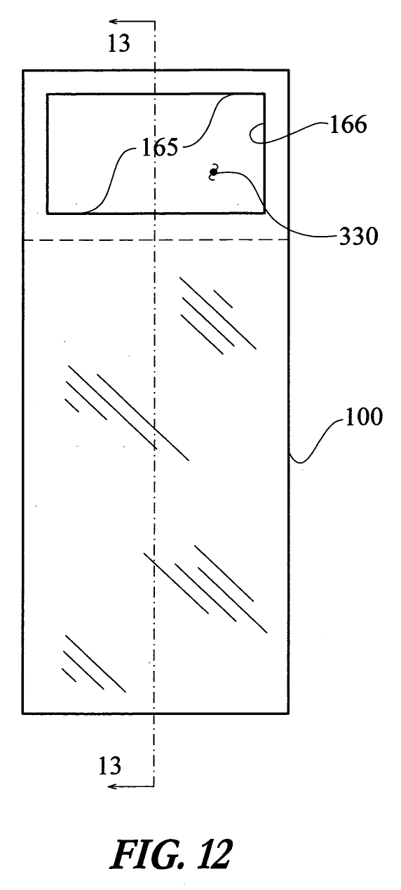

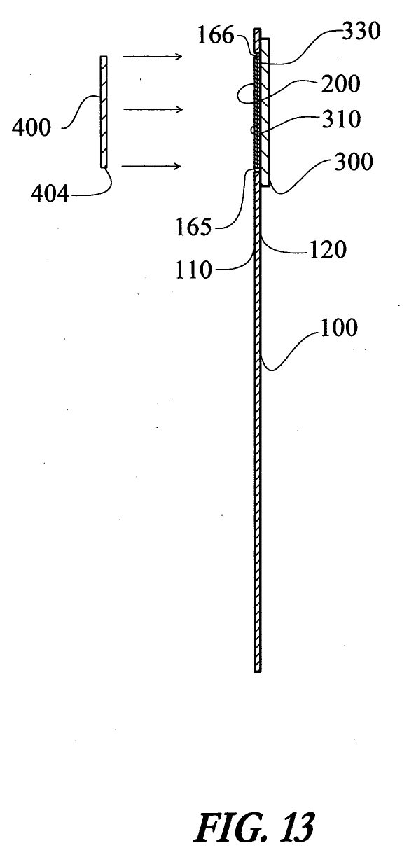

In yet another embodiment illustrated in FIGS. 12 and 13, the primary substrate (100) is formed with an attachment recess (165) having a recess perimeter (166). The attachment recess (165) is a void in the primary substrate (100). As seen in FIG. 13, the attachment recess (165) extends from the primary substrate display surface (110) to the primary substrate rear surface (120). The recess perimeter (166) is substantially the same as a customized attachment perimeter (404). A magnetic substrate permanent adhesive layer (330) resides on a magnetic substrate contact surface (310). The magnetic substrate (300) is exposed by the presence of the attachment recess (165) and provides the support for the customizable attachment (400). The release liner (200) covers the magnetic substrate permanent adhesive layer (330). Following removal of the release liner (200), the customizable attachment (400) is permanently adhered to the magnetic substrate permanent adhesive layer (330) within the attachment recess (165). In this embodiment, the attachment recess (165) allows the customized attachment (400) to fit in a substantially flush manner into the primary substrate (100). When the customized attachment perimeter (404) substantially abuts the recess perimeter (166), the aesthetic appearance of the universal magnetic customizable promotional piece (10) is greatly improved. In one particular embodiment, the attachment recess (165) has a rectangular shaped recess perimeter (166) that is substantially the same shape and size of a standard business card. All of the attributes of the previously described permanent adhesive layer (150) apply equally to the magnetic substrate permanent adhesive layer (330).

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A universal magnetic customizable promotional piece (10) for permanently attaching a customized attachment (400) thereto, comprising:
a primary substrate (100) having a primary substrate display surface (110) and a primary substrate rear surface (120), wherein the primary substrate (110) has a universal promotion display portion (130) and a customizable attachment display portion (140) separated by a demarcation line (170), and the customizable attachment display portion (140) is covered in part by a permanent adhesive layer (150) sized to generally cooperate with the customized attachment (400);
a release liner (200) having a release liner exterior surface (220) and a release liner contact surface (210), wherein the release liner (200) releasably covers the adhesive layer (150), whereby the release liner (200) is easily removed from the adhesive layer (150) by the application of force by a human hand so that when the customized attachment (400) is brought in contact with the adhesive layer (150), the customized attachment (400) is permanently attached thereto; and
a magnetic substrate (300) having a magnetic substrate exterior surface (320) and a magnetic substrate contact surface (310), wherein the magnetic substrate contact surface (310) is attached to the primary substrate rear surface (120), whereby the universal magnetic customizable promotional piece (10) may be releasably magnetically attached to a ferrous object.

2. The universal magnetic customizable promotional piece (10) of claim 1, wherein the demarcation line (170) is a separation line (172) imparting a line of reduced strength in the primary substrate (100) such that the universal promotion display portion (130) may be torn from the customizable attachment display portion (140).

3. The universal magnetic customizable promotional piece (10) of claim 1, wherein the release liner (200) is formed with a gripping tab (230) designed to cooperate with human fingers.

4. The universal magnetic customizable promotional piece (10) of claim 1, wherein the customized attachment (400) has a customized attachment width (402) and the primary substrate (100) has a primary substrate width (105), and the primary substrate width (105) is substantially equal to the customized attachment width (402).

5. The universal magnetic customizable promotional piece (10) of claim 4, wherein the customized attachment (400) is a standard size business card.

6. The universal magnetic customizable promotional piece (10) of claim 1, wherein the surface area of the customizable attachment display portion (140) is substantially equal to the surface area of the standard size business card.

7. The universal magnetic customizable promotional piece (10) of claim 1, wherein the permanent adhesive layer (150) is comprised of at least two noncontiguous permanent adhesive layers (150) located in the customizable attachment display portion (140).

8. The universal magnetic customizable promotional piece (10) of claim 7, wherein the at least two noncontiguous permanent adhesive layers (150) include a first adhesive area, a second adhesive area, a third adhesive area, and a forth adhesive area, wherein each of the adhesive areas is located at a corner of the customizable attachment display portion (140).

9. A universal magnetic customizable promotional piece (10) for permanently attaching a customized attachment (400) thereto, comprising:
a primary substrate (100) having a primary substrate display surface (110) and a primary substrate rear surface (120), wherein:
(i) the primary substrate (100) has a universal promotion display portion (130) and a customizable attachment display portion (140) separated by a demarcation line (170),
(ii) the customizable attachment display portion (140) has a liner passage (146), extending from the primary substrate display surface (110) to the primary substrate rear surface (120), and
(iii) the customizable attachment display portion (140) is covered in part by a permanent adhesive layer (150) sized to generally cooperate with the customized attachment (400);
a release liner (200) having a drawstring (240), a release liner exterior surface (220), and a release liner contact surface (210), wherein the release liner (200) releasably covers the adhesive layer (150), whereby the release liner (200) may be easily removed from the adhesive layer (150) by pulling the drawstring (240) and the release liner (200) through the liner passage (146) thereby removing the release liner (200) from the adhesive layer (150) in an efficient manner so that when the customized attachment (400) is brought in contact with the adhesive layer (150), the customized attachment (400) is permanently attached thereto; and
a magnetic substrate (300) having a magnetic substrate exterior surface (320) and a magnetic substrate contact surface (310), wherein the magnetic substrate contact surface (310) is attached to the primary substrate rear surface (120), whereby the universal magnetic customizable promotional piece (10) may be releasably magnetically attached to a ferrous object.

10. The universal magnetic customizable promotional piece (10) of claim 9, wherein the demarcation line (170) is a separation line (172) imparting a line of reduced strength in the primary substrate (100) such that the universal promotion display portion (130) may be torn from the customizable attachment display portion (140).

11. The universal magnetic customizable promotional piece (10) of claim 9, wherein the customized attachment (400) has a customized attachment width (402) and the primary substrate (100) has a primary substrate width (105), and the primary substrate width (105) is substantially equal to the customized attachment width (402).

12. The universal magnetic customizable promotional piece (10) of claim 11, wherein the customized attachment (400) is a standard size business card.

13. The universal magnetic customizable promotional piece (10) of claim 9, wherein the surface area of the customizable attachment display portion (140) is substantially equal to the surface area of the standard size business card.

14. A universal magnetic customizable promotional piece (10) for permanently attaching a customized attachment (400) thereto, comprising:
a primary substrate (100) having a primary substrate display surface (110) and a primary substrate rear surface (120), wherein the primary substrate (100) has a universal promotion display portion (130) and a customizable attachment display portion (140) separated by a demarcation line (170), and the customizable attachment display portion (140) is formed with an attachment recess (165) having a recess perimeter (166);
a magnetic substrate (300) having a magnetic substrate exterior surface (320), a magnetic substrate contact surface (310), and a magnetic substrate permanent adhesive layer (330) on a portion of the substrate contact surface (310), wherein the magnetic substrate contact surface (310) is attached to the primary substrate rear surface (120), the magnetic substrate adhesive layer (330) spans a portion of the attachment recess (165), whereby the magnetic substrate permanent exterior surface (320) may be releasably magnetically attached to a ferrous object; and
a release liner (200) having a release liner exterior surface (220) and a release liner contact surface (210), wherein the release liner (200) releasably covers the adhesive layer (150), whereby the release liner (200) is easily removed from the adhesive layer (150) by the application of force by a human hand so that when the customized attachment (400) is brought in contact with the adhesive layer (150), the customized attachment (400) is permanently attached thereto.

15. The universal magnetic customizable promotional piece (10) of claim 14, wherein the demarcation line (170) is a separation line (172) imparting a line of reduced strength in the primary substrate (100) such that the universal promotion display portion (130) may be torn from the customizable attachment display portion (140).

16. The universal magnetic customizable promotional piece (10) of claim 14, wherein the release liner (200) is formed with a gripping tab (230) designed to cooperate with the human fingers.

17. The universal magnetic customizable promotional piece (10) of claim 14, wherein the customized attachment (400) has a customized attachment perimeter (404) and the attachment recess (165) has a recess perimeter (166), and the recess perimeter (166) substantially conforms to the customized attachment perimeter (404).

18. The universal magnetic customizable promotional piece (10) of claim 17, wherein the customized attachment (400) is a standard sized business card.

19. The universal magnetic customizable promotional piece (10) of claim 14, wherein the magnetic substrate permanent adhesive layer (330) is comprised of at least two noncontiguous magnetic substrate permanent adhesive layers (330) located in the attachment recess (165).

20. The universal magnetic customizable promotional piece (10) of claim 19, wherein the at least two magnetic substrate permanent adhesive layers (330) include a first adhesive area, a second adhesive area, a third adhesive area, and a forth adhesive area, wherein each of the adhesive areas is located at a corner of the attachment recess (165).
